(19) United States
(12) Patent Application Publication
(10) Pub. No.: US 2022/0395423 A1
(43) Pub. Date: Dec. 15, 2022

(54) DEVICES, SYSTEMS, AND METHODS FOR STIMULATION OF SKIN TO INCREASE LYMPHATIC FLOW

(71) Applicants: Ghassan S. Kassab, La Jolla, CA (US); Xiao Lu, San Diego, CA (US)

(72) Inventors: Ghassan S. Kassab, La Jolla, CA (US); Xiao Lu, San Diego, CA (US)

(21) Appl. No.: 17/841,654

(22) Filed: Jun. 15, 2022

Related U.S. Application Data
(60) Provisional application No. 63/210,561, filed on Jun. 15, 2021.

(51) Int. Cl. A61H 15/00

(52) U.S. Cl. CPC A61H 15/0078; A61H 2201/5023; A61H 2015/0021

(57) ABSTRACT

Stimulation devices and methods of using the same that provide stimulation to the skin of a patient to activate the somatosensory system in skin, thereby increasing the contraction of innervated lymphatic vessels in extremities to drain more volume of lymph and aid lymph drainage in extremities. The devices of the present disclosure include a body having at least one wheel thereon configured to engage the skin of a patient, the at least one wheel wheels to rotate and stimulate the skin. Methods for using such device for stimulating skin to increase lymphatic flow are also provided.

### PRIORITY

This U.S. patent application is related to and claims the priority benefit of U.S. Provisional Patent Application Ser. No. 63/210,561 to Kassab et al., filed Jun. 15, 2021, the contents of which is hereby incorporated by reference in its entirety into this disclosure.

### BACKGROUND

Lymphatic fluid is produced in tissue interstitial space and returns to blood circulation through lymphatic vessels. Spontaneous contraction of lymphatic vessels and unidirectional valves propel lymphatic fluid in one direction. The pacemaker cells are thought to reside within the muscle layer to generate action potentials to cause spontaneous contraction of lymphatic vessels. The lymphatic vessels also have a sympathetic noradrenergic innervation and therefore sympathetic stimulation may increase frequency of lymphatic contraction and lymph flow. It is reported that an acute pain stimulus increases lymph flow of the regional lymphatic system of sheep. The stimulus of cerebral ischemia increases the lymphatic pumping by mesenteric lymph duct. The mesenteric lymph flow of sheep could be increased threefold in volume in response to emotional (sympathetic) stimulation. The lymph formation rate, humoral factors, and neuropeptides also act as modulators of lymphatic tone and contraction.

Lymph flow stems from a combination of several driving forces, such as lymph production rate, vascular pulsation, skeletal muscle contraction imposed on lymphatic vessels, spontaneous and innervated contraction of lymphatic vessels. In various studies, lymph flow in various body regions also shows differences which suggests varied responses to local lymph production rate and drainage. In contrast with mesenteric lymphatic vessels, the study of lymph flow in lower extremities has particular significance on lymphedema due to lymphatic disorder as one of the etiologies of limb edema.

A novel device and method for increasing the flow in the lymphatic vessels of lower extremities would be well accepted in the marketplace.

### BRIEF SUMMARY

We investigated the pressure, frequency, and lymph flow of spontaneous contraction of the afferent lymphatic duct of swine inguinal node. A stimulus by skin rubbing (back and forth touch with palm of hand) of swine paw. We observed changes in the pressure, frequency, and lymph flow in the afferent lymphatic duct of inguinal node.

Our studies shows that a gentle skin rubbing can increase the flow in the lymphatic vessels of lower extremities. The gentle skin rubbing is innocuous mechanical stimulus. People generally feel comfortable with gentle skin rubbing and are willing to maintain the rubbing for a long period of time. Therefore, this finding may have therapeutic benefit because the lymph drainage can last a long period without any discomfort unlike massage or pressure applications known in the art. A series of innovative devices for gentle skin rubbing is designed to mimic the gentle skin rubbing used in our study.

### BRIEF DESCRIPTION OF DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 Principle of lymph flow measurement. An illustration of the constructed flow indicator to measure the very low flow in peripheral lymphatic vessel is depicted. The inner diameter of the tube is 0.58 mm (tubes with different diameters can be used for different flows). The tube is filled with ink at ˜1 cm and connected with the micro-catheter that cannulates the desired peripheral lymphatic vessel. A stopwatch is used to obtain the time when the ink moves a distance L and hence calculate average velocity.

FIG. 2 Typical tracing curves of lymphatic, venous, and arterial pressures. A) Animal was anesthetized and not stimulated with massage. B) Massaging the paw of animal can increase the pressure peaks per minute, which indicates the increase in lymphatic contractions per minute. C) The number of peaks returned to baseline level after termination of massage.

FIG. 3 shows the pressure-diameter relations of in-situ lymphatic vessel. Right: Diameter vs pressure. Left: Diameter ratio vs pressure.

FIG. 4 shows the active pressure-diameter relations of in-vitro lymphatic vessel. Right: diameter vs pressure. Left: diameter ratio vs pressure. Pre-conditioning was performed over 3 cycles. D₀ were different for each vessel.

FIG. 5 shows the passive pressure-diameter relations of in-vitro lymphatic vessel. Right: diameter vs pressure. Left: Diameter ratio vs pressure. Pre-conditioning was performed over 3 cycles. D₀ were different for each vessel.

FIG. 6 shows exemplary device number 1.

FIG. 7 shows exemplary device number 2.

FIG. 8 shows exemplary device number 3.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

### Materials and Methods

Six domestic swine, weighing 59±7 kg, were obtained from a certified vendor and randomly assigned into two groups. The animals were carefully evaluated for pre-existing disease and acclimated for 3-days before undergoing surgical procedure. All animal experiments were performed in accordance with national and local ethical guidelines, including the Principles of Laboratory Animal Care, the Guide for the Care and Use of Laboratory Animals and the National Society for Medical Research. The research protocol was approved by the IACUC of California Medical Innovations Institute.

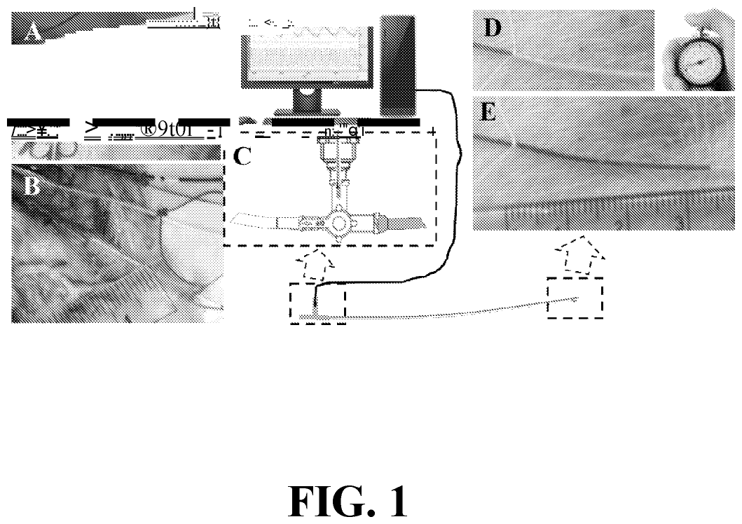

In Vivo Pressure and Flow Measures: The pigs were pre-anesthetized with Telazol (50 mg/ml), Ketamine (25 mg/ml), and Xylazine (25 mg/ml) and maintained with 2% Isoflurane. Blood pressure cuff was then placed at forearm. The surgical sites were shaved and cleaned in preparation for catheterization and instrumentation. Venous and arterial accesses were established using the introducer sheathes placed into the jugular vein and femoral artery for monitoring venous and arterial pressure. Saline with 2% Evans Blue (Fishers Scientific) was injected into subcutaneous intervals of swine hind paws to visualize the peripheral lymphatic vessels (FIG. 1A). Guided by the ink, the subcutaneous lymphatic vessels near inguinal node were exposed by a skin incision. The target lymphatic vessels were dissected free from adjacent tissue with aid of surgical microscope (MOLLER-WEDEL GmbH&Co. KG). A homemade micro-catheter (OD: 0.5 mm) was inserted into the lymphatic vessel to cannulate the vessels (FIG. 1B). The cannulation was secured with 8-0 suture. The micro-catheter was connected to one port of a three-way stopcock (FIG. 1). A Tuohy-Borst adapter was attached into another port of the stopcock (FIG. 1C). A catheter transducer for pressure measurements (MIKRO-TIP SPR-524, Millar) was sealed into the Tuohy-Borst adapter (FIG. 1C). The pressure transducer was linked to amplifier/interface (MP150, Biopac). The pressure in peripheral lymphatic vessel was measured with a pressure transducer. The digital data of the lymphatic pressure were saved in computer for analysis. We analyzed the period of single pulse pressure (L1Tp), the interval period of pulse-to-pulse pressure (L1Tp-p), and maximum and minimum pressures. One long micro-tube (ID: 0.58 mm, Length: 30 cm) was pre-filled with ink over approximately 6 cm length to form a moving ink piston marker (FIG. 1D). The ink piston was pushed forward when the lymph flowed into the micro-tube (FIGS. 1D&E). The lymph flow in peripheral lymphatic vessel was measured when the micro-tube was connected to the lymphatic vessel. The start-point of the ink piston was marked with a suture knot and the time (t) was measured when the ink traveled from the knot to a distance (L). The volume flow rate (Q) is given by conservation of mass as:

$$Q = π {r}^{2} \frac{L}{t}$$

where r=ID/2 is the inner radius of the micro-tube.

Stimulation by Rubbing Skin: A mechanical stimulation was applied on the lateral paw. A palm of hand touched the anterior paw with back-and-forth movement to rub the skin of the paw. The frequency of the back-and-forth motion was approximately 0.5 Hz. The approximately 1 N force of the palm (˜70 cm²) to compress on the skin was calibrated using a weighing scale, i.e., 0.17 kPa pressure on skin. The duration of the rubbing was approximate 10 min. The lymphatic pressure and flow were measured in the afferent lymphatic vessels of inguinal node.

Pressure-Diameter Relations: After the pressure and flow measurement, the in-situ vessels were pressurized with stepwise increase in pressures: 0-10 (in increments of 1 cmH₂O), 12-18 (in increments of 2 cmH₂O), and 20-30 (in increments of 5 cmH₂O). The diameters were recorded at every pressure with a camera mounted to the surgical microscope. The vessels were also excised and cannulated for in-vitro pressure-diameter relationship. The vessels were cannulated and secured with 9-0 suture and incubated in 37° C. physiological saline solution (PSS). The vessels were pressurized with stepwise increase in pressures and the diameters were recorded at every pressure. The physiological saline solution was replaced with calcium-free saline solution (3 mM EGTA) to obtain passive pressure-diameter relationship.

Statistical Analysis: The data are presented as mean±SD. Significant differences between any two groups were determined by Student's t-test (two-tailed distribution, two-sample unequal variance) or Analysis of Variance (ANOVA, Bonferroni test). A probability of p<0.05 was considered indicative of a statistically significant difference.

### Results

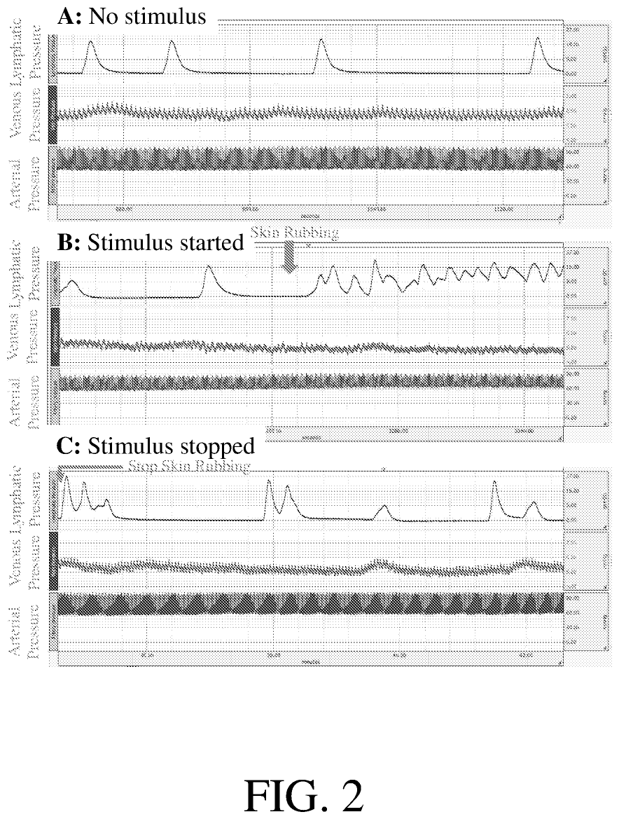

Lymphatic Pressures: Typical curve of peripheral lymphatic pressure are presented in FIG. 2. Without skin rubbing, the lymphatic pressure shows discontinuous peaks (intermittent pulse) with interval from 1 to 3 minutes between peaks (FIG. 2A). When skin rubbing was applied on the paw of the animal, the number of intermittent pressure peaks increased, and a continuous pressure waveform was observed (pulsation in FIG. 2B). When skin rubbing stopped, the number of pressure peaks decreased to similar level at rest in approximately 10 minutes (FIG. 2C). The maximum and minimum values of pulse pressure increased from 4.6±1.8 and 1.3±0.9 in control (spontaneous contraction) to 21.8±11.3 and 16.5±10.5 mmHg during skin rubbing (Table 1), respectively. The period of pulse pressure decreased from 12.3±3.5 in control (spontaneous contraction) to 7.5±1.8 s during skin rubbing (Table 1). The interval period of intermittent pulse pressure decreased from 101±65.7 in control (spontaneous contraction) to 0 s during skin rubbing (Table 1), i.e., continuous pulsation.

TABLE 1
Lymph flow and pressure in the lymphatic vessel of lower extremities

| | | Control | SCS | p value |
|---|---|---|---|---|
| Pressure | ΔTₚ (s) | 12.3 ± 3.5 | 7.5 ± 1.8 | <0.01 |
| Peaks | ΔTₚ₋ₚ (s) | 101 ± 65.7 | 0 | <0.01 |
| mmHg | Max | 4.6 ± 1.8 | 21.8 ± 11.3 | <0.01 |
| | Min | 1.3 ± 0.9 | 16.5 ± 10.5 | <0.01 |

| | | | |
|---|---|---|---|
| Q (ml/min) | 0.9 ± 0.7 | 3.3 ± 2.1 | <0.01 |

SCS: Skin rubbing stimulus. ΔTₚ: The period of pulse pressure. ΔTₚ₋ₚ: The interval period of the pulse-to-pulse of pressure. Max: The maximal value of pulse pressure. Min: The minimal value of the pulse pressure. p value: Student's t-test.

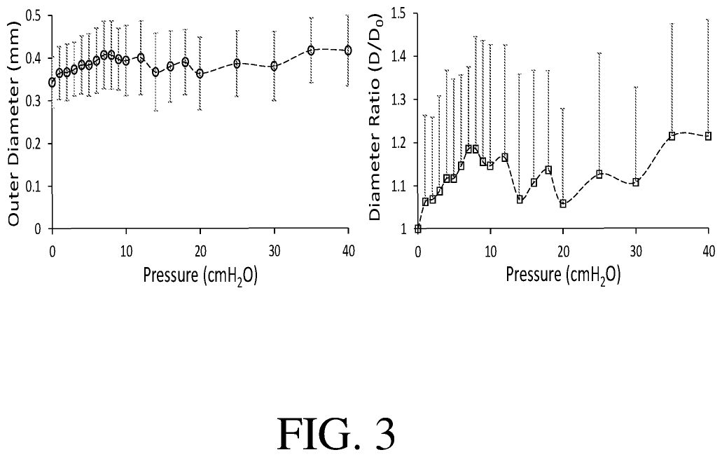

Lymph Flow: We observed that the lymph flow corresponded the to the pressure peaks, i.e., intermittent pulse of lymph flow corresponded to intermittent pulse pressure. When skin rubbing is applied on the paw of the animal, the lymph flow became continuous corresponded to the pressure pulsation. The flow increased from 0.9±0.7 in control (spontaneous contraction) to 3.3±2.1 μl/min during skin rubbing (Table 1). The increase in lymph flow is statistically significant during skin rubbing (p<0.05). The mean values of arterial and venous pressures did not change during the skin rubbing (FIG. 2). The arterial and venous pressures waveforms were not affected by the skin rubbing either (FIG. 3).

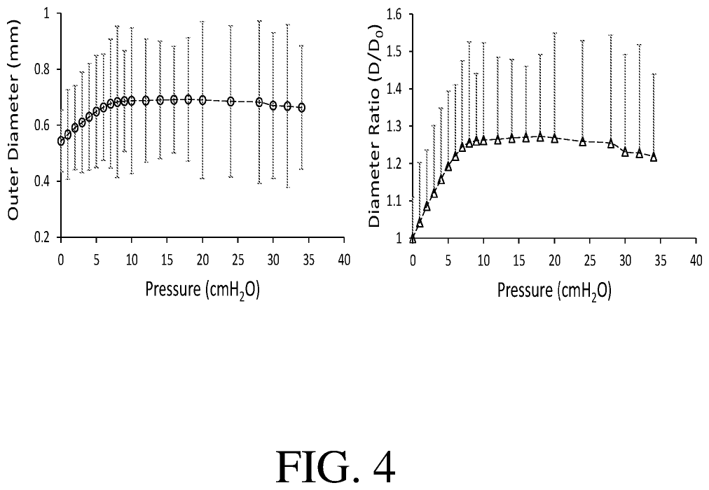

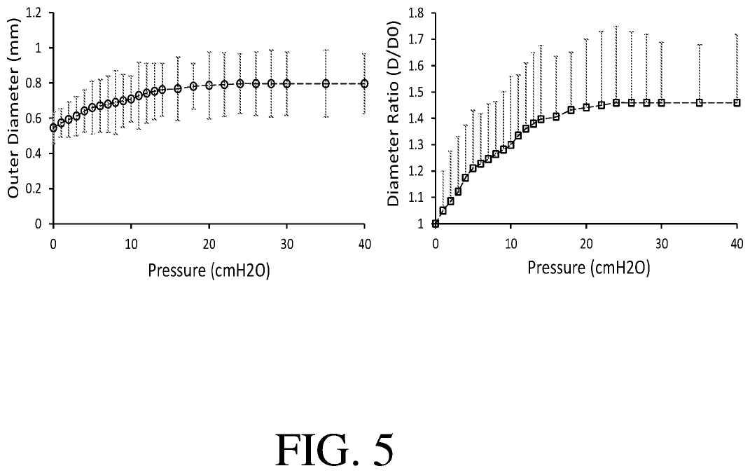

Pressure-Diameter Relation: The in-situ pressure-diameter relation of lymphatic vessels is shown in FIG. 3. The in-vitro pressure-diameter relation of lymphatic vessel in physiological saline solution at 37° C. is represented in FIG. 4. Although the in-vitro lymphatic vessel developed tone in physiological saline solution, the in-vitro diameter was statistically larger than the in-situ diameter (p<0.05, ANOVA). When the vessel was completely relaxed in calcium-free saline solution at 37° C. (passive), the in-vitro diameter of lymphatic vessel was further enlarged (FIG. 5). The in-vitro diameter in calcium-free saline solution is statistically larger than the in-vitro diameter in physiological saline solution (p<0.05, ANOVA).

### Discussion

The major finding of this study is that repetitious mechanical contact (i.e., skin rubbing) of the paw of swine results in pulsatile waves of pressure and flow with significant increase in lymph flow during the stimulation. A casual relation was found such that when rubbing was stopped, the pulsatile waves ceased, and flow decreased significantly back to baseline. The in-situ pressure and diameter relation showed significant myogenic tone which was diminished when the vessels were removed and transferred to organ bath for in-vitro test of pressure-diameter relation.

The observation on the intermittent pulse pressure and flow in the in-vivo lymphatic vessel is consistent with previous studies on the lymphatic vessels, which suggests that local regulator (pacemaker cells possibly) is key in spontaneous contractions. We observed the increases in pressure and flow in the lymphatic vessels in response to the skin rubbing stimulus. It is well-known that somatosensory system in the skin decodes the tactile stimuli on skin. The primary sensory neurons are activated by the mechanical forces imposed on the skin. The low-threshold mechanoreceptors (LTMRs) react to innocuous mechanical stimulation. The high-threshold mechanoreceptors (HTMRs) react to harmful mechanical stimuli. The motor neurons can be activated by the synapse in spinal cord in the neural pathway of sensory activation (reflex arc).

The study on the acute pain stimulus resulting in elevated popliteal lymph flow in anesthetic sheep suggests that reflex arc may regulate the lymph flow in extremities. The role of neural regulation was also demonstrated in a study in which sympathetic stimulation at spinal cord increased lymph output from popliteal node in anesthetized sheep. Based on these past studies, we speculate that the neural system is likely at play in the skin rubbing which results in increase of lymph flow in lower extremities.

A manual lymphatic drainage (MLD), a physical therapy, has been proposed to aid transport of lymph from the extremities. MLD uses a specific amount of pressure <9 ounces per square inch (4 kPa). Although the advantages of MLD are reported in individual studies, the benefits for MLD in reducing lymphoedema volume are still controversial, partially because the mechanism of MLD is not completely understood. There is no doubt that the pressure of MLD (4 kPa) imposed on skin not only stimulates the cutaneous sensory neurons but also compresses and stimulates the deep tissues. In the current study, we applied pressure at approximately 0.17 kPa on the skin which was approximate 4% of the pressure of MLD. The skin rubbing, therefore, primarily stimulates the cutaneous sensory neurons, but does not compress or stimulate deep tissues. We measured the lymph flow and pressure near inguinal nodes, which was over 30 cm away from the site of skin rubbing on the paws. Therefore, local responses (spontaneous contraction, passive squeeze, etc.) were excluded. The observation of the increase in lymph flow suggest that the cutaneous sensory system is involved in lymph transport in lower extremities in response to the skin rubbing stimulus. Skin rubbing is a gentle stimulus and can be comfortably applied to extremities to accelerate lymph drainage over long duration unlike compressive pressures that can reduce blood flow and cannot be tolerated over long durations. Therefore, skin rubbing may have therapeutic benefit to reduce edema of lower extremities.

The myogenic tone of the lymphatic vessels was decreased as reflected m the in-vitro pressure-diameter test relative to the in-situ. Given the innervation of lymphatic vessels, the neural activation may contribute to the myogenic tone of lymphatic vessel. It is well established that the contraction of lymphangion (intrinsic pumping) combined with the valve action ensures one way flow of lymph. Obviously, the myogenic tone is an important factor for lymph transport because the diameter may determine the stroke volume in each contraction of lymphatic vessel. Furthermore, the dimension of the diameter can affect valve function, i.e., lymphatic insufficiency if diameter is overly dilated. Therefore, a suitable myogenic tone that regulates the diameter of the lymphatic vessel is critical for effective lymph transport. Our observation on the lymphatic vessels in lower extremities suggests that the myogenic tone can be regulated through a mechanical innervation.

Physiological and pathological factors affect the lymphatic system and likely alter the recirculation of lymph. A lymphatic dysfunction may be an etiology of chronic lower-extremity edema. When lymphatic system is dysfunctional, the lymph cannot be returned to the blood system at the same rate as it leaves and hence painful and debilitating condition of edema can develop. All chronic edema indicate an inadequacy or failure of lymph drainage. The mechanism of lymphoedema is largely uncertain. It is known that heart failure, nephrotic syndrome, liver diseases, infection, cancer, and obesity are involved in lymphoedema. A failure of transport in collecting lymphatic vessels is recognized as an etiological factor in edema. Interference with lymphatic pumping, e.g., calcium influx for the pacemaker potential, may also cause peripheral edema. Lymphatic valve dysfunction, and consequently lymph reflux, may also be one of the mechanisms for the development of lymphedema.

The somatosensory system decodes a wide range of tactile stimuli. Innocuous mechanical stimuli acting on the skin are detected by cutaneous sensory neurons (LTMRs). The activation of LTMRs may be affected by the distribution of sensory neurons, anesthesia, temperature, etc., besides the compression pressure and frequency of skin rubbing. Therefore, a precise quantification of sensory stimulation needs to be developed in future studies in addition to quantifications of compression pressure and frequency of skin rubbing. Denervation is an effective method to implicate the involvement of neural system in the stimulus-response of lymphatic system. It has been demonstrated that the stimulation at lumbar sympathetic chain may result in the increase in lymph flow in afferent vessel of popliteal nodes. The lumbar sympathetic chain is, however, the neural network surrounding vertebra. Several amputations on the lumbar sympathetic chain may not disconnect the lumbar sympathetic chain to the neurons in lymphatic vessels in lower extremities. Precise disconnection between lumbar sympathetic chain and the neurons in lymphatic vessel in lower extremities need to be developed in future study. Furthermore, the role of neural system in lymphatic response to pathological conditions (e.g., lymphoedema) should be investigated in future studies.

In this study, we found an increase in lymphatic pressure and flow in response to the mechanical stimulus of skin rubbing which may have therapeutic benefit. The potential mechanism of this phenomena may be mediated through the innervation of lymphatic vessels. The investigation of the role of neural function in the etiology of lymphoedema and potential therapy is a laudable goal of future studies.

### Exemplary Treatment Devices

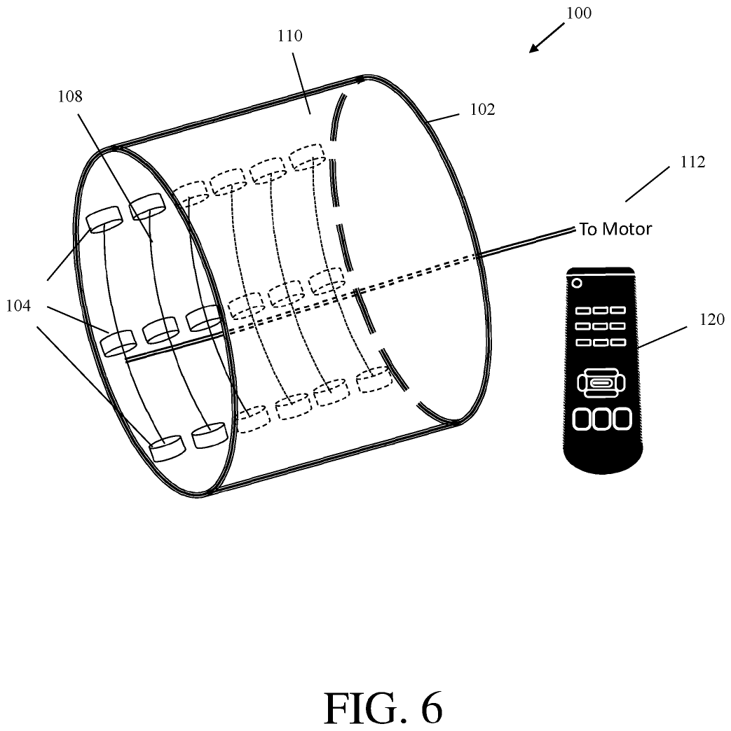

FIG. 6 depicts an exemplary stimulation device 100 of the present disclosure. The stimulation device 100 comprises a flabby adjustable cuff 102 (loosely fitting without compression) and a remote control 120 to adjust the degree of shearing or rubbing effect. The cuff 102 comprises a series of wheels 104 and a textile sleeve 110. The cuff 102 may be loosely mounted rather than tightly fastened on extremities, i.e., the skin under the cuff 102 is not compressed by the cuff 102. The pressure of each wheel 104 on the skin is <0.2 kPa (0.45 ounce per square inch) which is approximately equivalent to a finger gently touching on skin. The textile sleeve 110 accommodates the wheels 104. The wheels 104 are made of ePTFE (expanded polytetrafluoroethylene) which is light and soft. The ePTFE is an implantable material and therefore nontoxic and nonharmful to the skin. The axles 108 of the wheels are strutted in the textile sleeve 110. The wheels 104 can rotate driven by a motor 112 attached to the axles 108. The wheel rotation provides a shear force on skin to provide a gentle skin rubbing. We demonstrated that the skin rubbing could activate somatosensory system in skin and the activation of somatosensory system increased the contraction of innervated lymphatic vessels in extremities to drain more volume of lymph. Therefore, the innovative device can aid lymph drainage in extremities. The rotation speed and duration of each wheel 104 are controllable and programmable. The rotation speed is adjustable from 3 to 10 cycle/min. The rotation duration is adjustable from 5 to 35 min or longer. The remote 120 can control the rotation speed and duration. The remote 120 also changes the programs of the wheel rotation in the textile sleeve 110 for comfortable parameters.

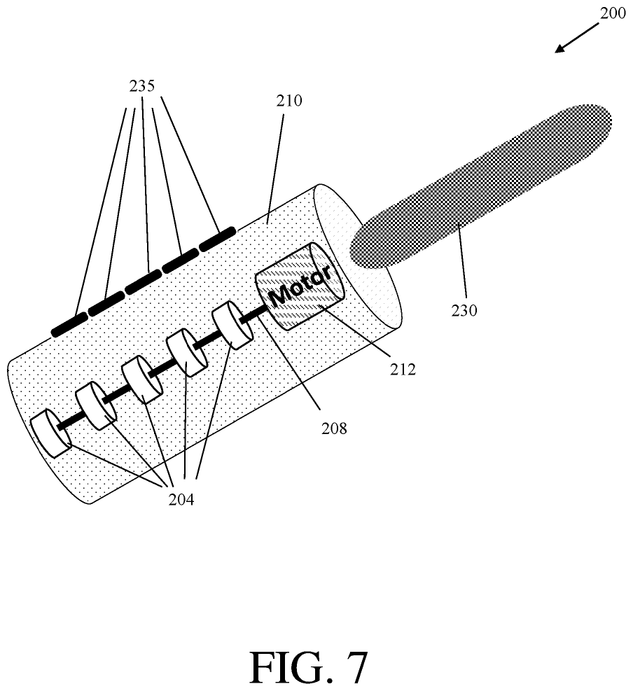

FIG. 7 depicts an exemplary stimulation device 200 of the present disclosure. The stimulation device 200 comprises rotative wheels 204 (made of ePTFE) and a roller 210, the wheels 204 being installed on the roller 210. The axle 208 of the wheels is connected to a motor 212 on the roller 210. The axle 208 of the wheels 204 is strutted in the roller 210. The wheels 204 can rotate driven by the motor 212 attached to the axles 208 in the roller 210. The wheel rotation provides a shear force on skin to provide a gentle skin rubbing. A handle 230 is attached to the roller 210 for hand gripping. There are five control buttons 235 on the roller to adjust the rotation speed and duration of each wheel.

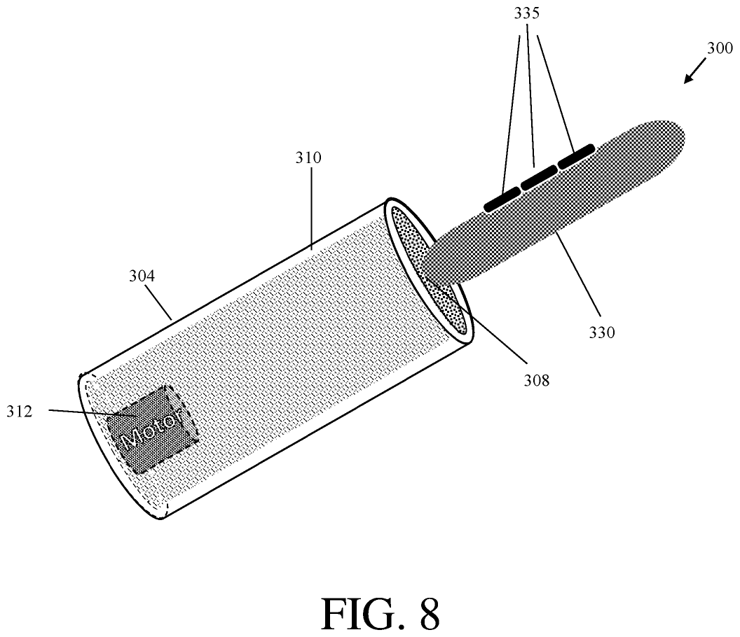

FIG. 8 depicts an exemplary stimulation device 300 of the present disclosure. A cylindrical wheel 304 (made of ePTFE) is installed on a roller 310 which covers the roller 310. The axle 308 of the wheel 304 is connected to a motor 312 on the roller 310 at two ends. The axle 308 of the wheel is strutted in the roller 310. The wheel 304 can rotate driven by the motor 312 attached to the axles 308. The wheel rotation provides a shear force on skin to provide a gentle skin rubbing. A handle 330 is attached the roller 310 for hand gripping. There are three control buttons 335 on the handle 330 to adjust the rotation speed and duration of the cylindrical wheel 304.

Prolonged rubbing can irritate the skin if the surface of the device has high friction coefficient. Hence, we select low friction of coefficient materials (e.g., silicones, low friction plastics, etc.). The device surface can also be made to exude lubricants to reduce the friction and reduce the risk of skin irritation, rash, etc.

While various embodiments of devices for a skin rubbing device and methods for increasing lymphatic flow have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A device for stimulation of skin comprising:
a cuff comprising a series of wheels and a textile sleeve;
a motor operably connected to the wheels; and
a remote control to adjust the motor.
